(19) United States
(12) Patent Application Publication
(10) Pub. No.: US 2010/0004959 A1
(43) Pub. Date: Jan. 7, 2010

(54) Methods and system for reserving services from service providers

(76) Inventor: Robert Weingrad, Mamaroneck, NY (US)

Correspondence Address: MAIER & MAIER, PLLC, 1000 DUKE STREET, ALEXANDRIA, VA, 22314, US

(21) Appl. No.: 12/216,190

(22) Filed: Jul. 1, 2008

(51) Int. Cl. G06Q 10/00

(52) U.S. Cl. 705/5

(57) ABSTRACT

A method of connecting at least one first user with at least one second user is provided. The method includes connecting at least one consumer and at least one service provider to a web portal, wherein the at least one consumer is seeking a service and the at least one service provider provides the service; establishing a direct communication connection between the at least one consumer and the at least one service provider using the web portal to facilitate providing a platform to conduct business transactions such that the direct communication connection is substantially private, wherein the direct communication connection is relayed through the web portal; and transacting business between the at least one consumer and the at least one service provider using the web portal such that the at least one service provider sells the service to the at least one consumer directly.

### BACKGROUND

Existing online reservation websites, such as Travelocity.com, Orbitz.com, Hotels.com, Priceline.com, Expedia.com and Ticketmaster.com offer services from service providers at a predetermined or fixed price that the websites have contracted to represent. These websites initially contract with the service providers to purchase a bulk of their services at a fixed price which the websites re-sell to their online customers at marked-up price. In some known contracts, service providers agree to pre-sell their services to the websites at a lower rate than what they may typically offer directly to customers. Moreover, the service providers may have to pre-sell their services at greatly reduced prices to entice the websites to contract with and represent the service providers. In return for these low profit-margin rates, the service providers generally receive a steady flow of reservations for their services from the customers using the websites.

Such methods of pre-selling services do not necessarily benefit the service provider or the customer. Specifically, customers using the websites to reserve services may pay for a lower base service rate; however, the customer generally also pays a mark-up premium, taxes and other fees, such that the customer receives no real savings in using the website to reserve the service.

Moreover, the service providers that use the websites are generally prevented from varying their service rates based on the day-to-day business factors that may cause the price of a service to fluctuate. As a result, service providers are less likely to capitalize on a greater demand for their services on a specific day or pass savings onto the customer on days of lower demand for their services.

### BRIEF DESCRIPTION

In one exemplary embodiment, a method of connecting at least one first user with at least one second user is provided. The method includes connecting at least one consumer and at least one service provider to a web portal, wherein the at least one consumer is seeking a service and the at least one service provider provides the service; establishing a direct communication connection between the at least one consumer and the at least one service provider using the web portal to facilitate providing a platform to conduct business transactions such that the direct communication connection is substantially private, wherein the direct communication connection is relayed through the web portal; and transacting business between the at least one consumer and the at least one service provider using the web portal such that the at least one service provider sells the service to the at least one consumer directly.

In another exemplary embodiment, a computer program embodied on a computer-readable medium is provided. The computer program includes at least one code segment configured to instruct a computer to connect a consumer and a service provider to a web portal to facilitate establishing a direct communication connection between the consumer and the service provider, wherein the consumer is seeking a service and the service provider provides the service; send a service offer request from the consumer to the service provider, said service offer request comprises an offer request for a service performed by the service provider; send a service offer from the service provider to the consumer, said service offer comprises at least one of a service description, a service price and a service duration; send a confirmation of the service offer from the consumer to the service provider, wherein said confirmation comprises an acceptance of said service offer; and remit a payment from the consumer to the service provider for the service provided by the service provider.

### BRIEF DESCRIPTION OF THE DRAWINGS

Advantages of embodiments of the present invention will be apparent from the following detailed description of the exemplary embodiments. The following detailed description should be considered in conjunction with the accompanying figures in which:

FIG. 1 is a schematic illustration of a reservation system;

FIG. 2 is an enlarged schematic illustration of the system shown in FIG. 1;

FIG. 3 is an illustration of a reservation request page that may be used with the system shown in FIG. 1;

FIG. 4 is an illustration of a client reservation request page that may be used with the system shown in FIG. 1;

FIG. 5 is an illustration of a service and rate offer page that may be used with the system shown in FIG. 1;

FIG. 6 is an illustration of a payment page that may be used with the system shown in FIG. 1;

FIG. 7 is an illustration of a reservation amendment page that may be used with the system shown in FIG. 1;

FIG. 8 is an illustration of a client reservation amendment request page that may be used with the system shown in FIG. 1;

FIG. 9 is an illustration of an amendment offer page that may be used with the system shown in FIG. 1;

FIG. 10 is an illustration of an amendment settlement page that may be used with the system shown in FIG. 1;

FIG. 11 is an illustration of a cancellation page that may be used with the system shown in FIG. 1;

FIG. 12 is an illustration of a reservation cancellation confirmation page that may be used with the system shown in FIG. 1;

FIG. 13 is an illustration of a client reservation center login page that may be used with the system shown in FIG. 1;

FIG. 14 is an illustration of a client reservation page that may be used with the system shown in FIG. 1;

FIG. 15 is an illustration of a service provider reservation page that may be used with the system shown in FIG. 1; and

FIG. 16 is an illustration of a service provider home page that may be used with the system shown in FIG. 1.

### DETAILED DESCRIPTION OF THE INVENTION

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many of the embodiments described herein are described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the at least one processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, “a computer configured to” perform the described action.

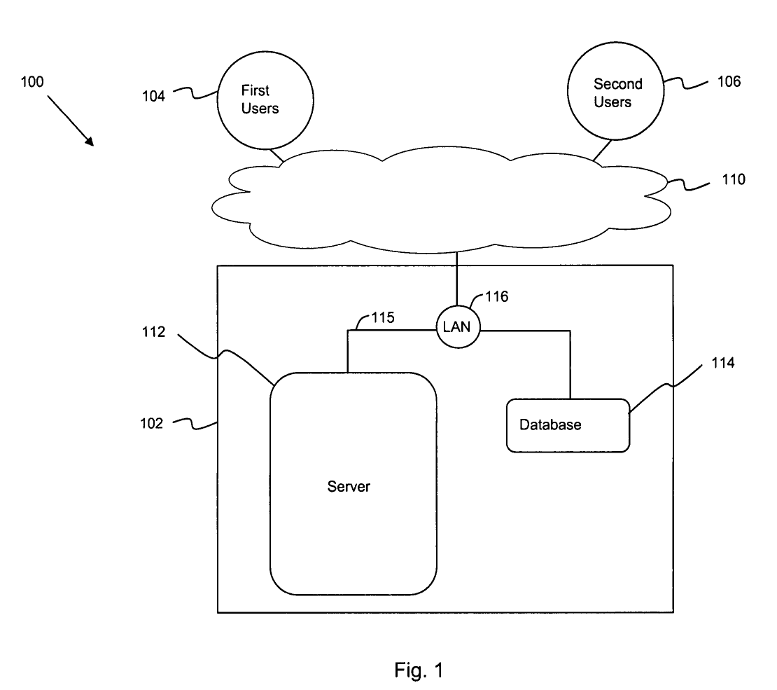

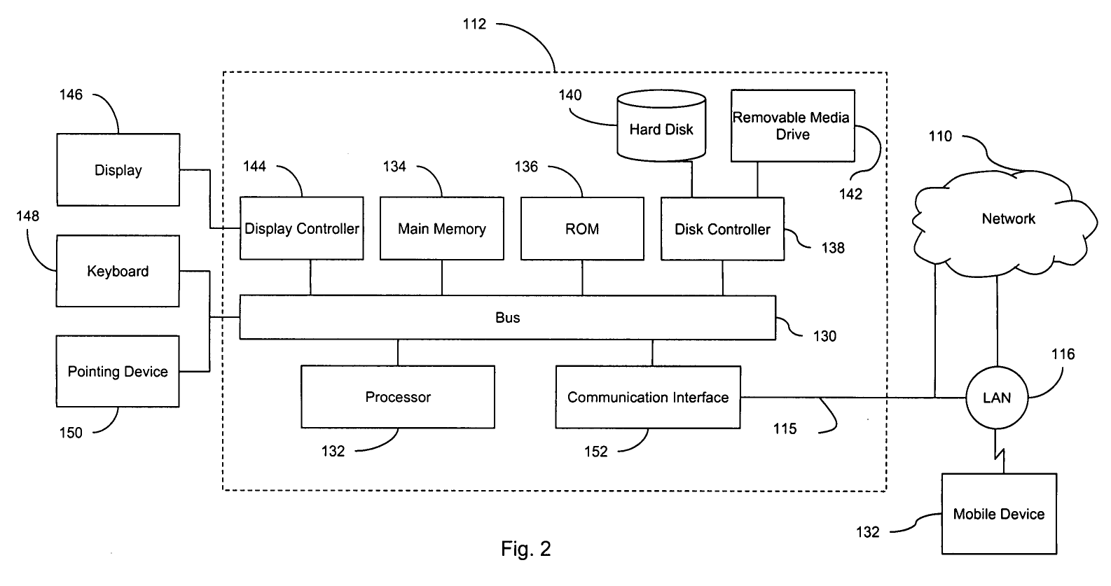

FIG. 1 is a schematic illustration of a reservation system 100. FIG. 2 is an enlarged schematic illustration of system 100. In the exemplary embodiment, system 100 may include a web portal 102, at least one first user 104 and at least one second user 106. In the exemplary embodiment, each first user 104 and each second user 106 may be coupled in communication to web portal 102 using a network 110. In the exemplary embodiment, network 110 may be the Internet. In an alternative embodiment, network 110 may be a local area network (LAN), a wireless LAN, a wide area network (WAN) and/or any other type of connection that enables system 100 to function as described herein. System 100, in the exemplary embodiment, may also include at least one server 112 and at least one database 114. In the exemplary embodiment, server 112 may be coupled in communication to database 114 using a network connection 115 that is coupled to a local network 116 such as, but not limited to, a LAN, a wireless LAN, a WAN and/or any other connection that enables system 100 to function as described herein.

In the exemplary embodiment, first users 104 may be any entity that desires to purchase services offered by second users 106. In one embodiment, first users 104 may be the general public. Second users 106 may be any entity, or service provider, that offers services to first users 104. In one embodiment, second users 106 may include, but not limited to, lodging businesses, rental businesses, travel businesses, event businesses and/or ticket sellers. In another embodiment, the services offered by second users 106 may include, but not limited to, lodging reservations, rental reservations, travel reservations and/or event reservations. As a result, system 100 may be used to, but not limited to, reserve hotels, purchase travel tickets, purchase event tickets, rent business, personal and/or real property, reserve event space and/or any other type of service provided by a service provider. In the exemplary embodiment, system 100 may be used to connect at least one first user 104 with at least one second user 106 using web portal 102 to facilitate establishing a business relationship between first users 104 and second users 106. Moreover, system 100 may be used to facilitate eliminating the need for a service broker that is positioned between first user 104 and second user 106, wherein the service broker may charge a fee to sell the services of second users 106 to first users 104. As such, system 100 facilitates eliminating a service broker fee that may be charged by the service broker.

In the exemplary embodiment, the term “server” is not limited to just those integrated circuits referred to in the art as a computer, but broadly refers to a processor, a microcontroller, a microcomputer, a programmable logic controller, an application specific integrated circuit and other programmable circuits. These aforementioned terms may be used interchangeably herein. In the exemplary embodiment, server 112 may include a bus 130 or other communication mechanism for communicating information, and a processor 132 coupled with bus 130 for processing the information. In one embodiment, a plurality of processors 132 may be arranged in a multi-processor arrangement to facilitate faster processing as compared to a single processor arrangement. In the exemplary embodiment, system 100 may also include a main memory 134, such as a random access memory (RAM) or other dynamic storage device (e.g., dynamic RAM (DRAM), static RAM (SRAM) and synchronous DRAM (SDRAM)) coupled to bus 130 for storing information and instructions to be executed by processor 132. In addition, main memory 134 may be used for storing temporary variables or other intermediate information during the execution of instructions by processor 132. System 100 may further include a read only memory (ROM) 136 or other static storage device (e.g., programmable ROM (PROM), erasable PROM (EPROM) and electrically erasable PROM (EEPROM)) coupled to bus 130 for storing static information and instructions for processor 132.

System 100 may also include a disk controller 138 coupled to bus 130 to control one or more storage devices for storing information and instructions. In the exemplary embodiment, storage devices may include, but not limited to, a magnetic hard disk 140 and a removable media drive 142 (e.g., floppy disk drive, read-only compact disc drive, read/write compact disc drive, compact disc jukebox, tape drive and removable magneto-optical drive). The storage devices may be coupled to system 100 using any appropriate device interface known to one having ordinary skill in the art (e.g., small computer system interface (SCSI), integrated device electronics (IDE), enhanced-IDE (E-IDE), direct memory access (DMA), or ultra-DMA). System 100 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

In the exemplary embodiment, main memory 134, hard disk 140 and removable media drive 142 are examples of computer-readable mediums that facilitate holding instructions programmed according to the teachings of the invention, data structures, tables, records and/or other data described herein. The term “computer-readable medium” or “computer-readable media” as used herein refers to any medium that facilitates storing and/or providing instructions to processor 132 for the execution thereof. The computer-readable media may include, but not limited to, non-volatile media, volatile media and transmission media. Non-volatile media may include, but not limited to, hard disks, floppy disks, tape, magneto-optical disks, PROMs (EPROM, EEPROM, flash EPROM), DRAM, SRAM, SDRAM or any other magnetic medium. Moreover, non-volatile media may also include compact discs (e.g., CD-ROM) or any other optical medium. Further, non-volatile media may include punch cards, paper tape or other physical medium with patterns of holes. Volatile media may include dynamic memory, such as main memory 134. Transmission media may include coaxial cables, copper wire and fiber optics, including the wires that make up bus 130. Transmission media may also include carrier waves such as acoustic or light waves that may be generated using radio waves and infrared data communications.

In the exemplary embodiment, the computer-readable media may include software that facilitates controlling system 100. Such software may include, but is not limited to, device drivers, operating systems, development tools and applications software. Such computer-readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

In the exemplary embodiment, system 100 may further include a display controller 144 coupled to bus 130 to control a display 146, such as a cathode ray tube (CRT), liquid crystal display (LCD) or any other type of display to facilitate displaying information to a computer user. System 100 may include a plurality of input devices, such as a keyboard 148 and a pointing device 150, to facilitate interacting with the computer user and providing information to processor 132. Alternatively, a touch screen may be used in conjunction with display 146. In one embodiment, pointing device 150 may be a mouse, a trackball or a pointing stick for communicating direction information and command selections to processor 132 and for controlling cursor movement on display 146. In addition, a printer (not shown) may be coupled to system 100 to facilitate printing data stored and/or generated by system 100.

System 100 also includes a communication interface 152 coupled to bus 130, wherein communication interface 152 may be coupled in communication to LAN 116 or network 110 using network connection 115. In one embodiment, communication interface 152 may be a network interface card that is coupled in communication to any packet switched LAN. In another embodiment, communication interface 152 may be an asymmetrical digital subscriber line (ADSL) card, an integrated services digital network (ISDN) card or a modem to facilitate providing a data communication connection to network connection 115. In yet another embodiment, wireless connections may be used to couple communication interface 152 to LAN 116 and/or network 110. In the exemplary embodiment, communication interface 152 sends and receives electrical, electromagnetic or optical signals that carry digital data to and from system 100, which are exemplary forms of carrier waves that facilitate transporting information. Network connection 115 facilitates providing data communication between web portal 102 and data devices using networks 116 and 130. Specifically, network connection 115 may couple first users 104 and/or second users 106 to web portal 102 using at least one of local network 116 and network 110. System 100 may also transmit and receive data, including program code, through networks 116 and 110 using network connection 115 and communication interface 152. Moreover, network connection 115 may couple server 112 in communication to a mobile device 132 such as a personal digital assistant (PDA), a laptop computer, a cellular telephone, a smart phone, an ultra-compact mobile device or any other mobile device that enables system 100 to function as described herein.

During operation, system 100 may perform a portion or all of the processing steps of the invention in response to processor 132 executing one or more sequences of one or more instructions contained within main memory 134 and/or other forms of computer-readable media. In one embodiment, processor 132 may execute the instructions contained within the computer-readable media. In another embodiment, hard-wired circuitry may be used in place of or in combination with the instructions. Thus, the exemplary embodiments described herein are not limited to any specific combination of hardware circuitry and software. For example, the instructions may initially be carried on a magnetic disk of a remote computer. The remote computer can load the instructions for implementing all or a portion of the present invention remotely into a dynamic memory and send the instructions over a telephone line using a modem. A modem local to system 100 may receive the data on the telephone line and use an infrared transmitter to convert the data to an infrared signal. An infrared detector coupled to bus 130 can receive the data carried in the infrared signal and place the data on bus 130. Bus 130 carries the data to main memory 134, from which processor 132 retrieves and executes the instructions. The instructions received by main memory 134 may optionally be stored on hard disk 140 or removable media drive 142 either before or after execution by processor 132.

Other aspects of the invention may include data transmission and Internet-related activities. See Gralla, Preston, How the Internet Works, Ziff-Davis Press (1996), which is hereby incorporated by reference into this patent application. Still other aspects of the invention may utilize wireless data transmission, such as those described in U.S. Pat. Nos. 6,456,645, 5,818,328 and/or 6,208,445, all of which are hereby incorporated by reference into this patent application.

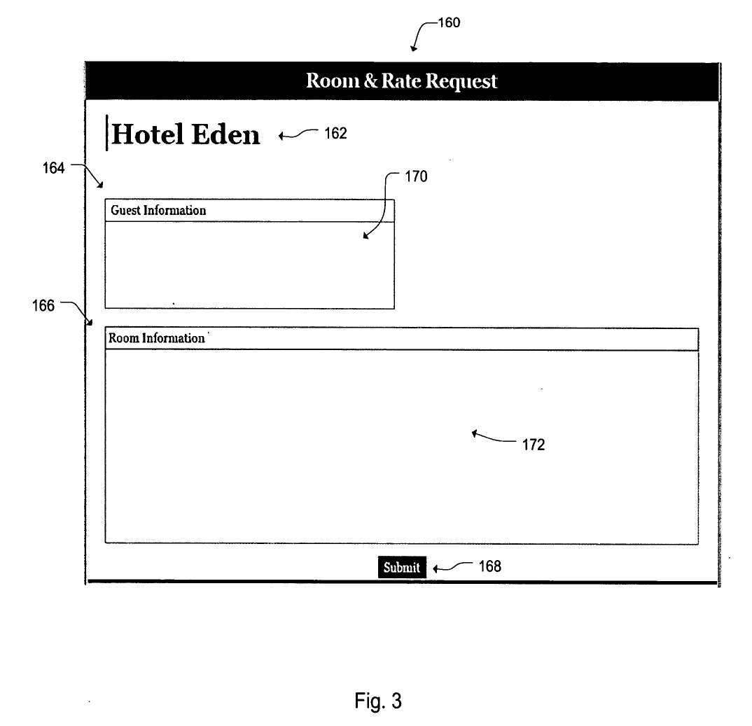

FIG. 3 is an illustration of a reservation request page 160 that may be used with system 100. Specifically, first users 104 may use reservation request page to request a service from second users 106. In the exemplary embodiment, reservation request page 160 may include a service provider name 162, a client information box 164, a service information box 166 and a submit button 168. Client information box 164 may include a plurality of client contact information 170 that may be entered into a plurality of data entry fields to facilitate collecting the client's contact information. In one embodiment, contact information 170 may include the client's name, email address and/or telephone number. Service information box 166 may include a plurality of service reservation details 172. In one embodiment, service reservation details 172 may include, but not limited to, the type of service and/or the desired duration of the service. In another embodiment, service reservation details 172 may include, but not limited to, an arrival date, a departure date, the number of adults, the number of children and a comment box. In the exemplary embodiment, submit button 168 facilitates sending the information within reservation request page 160 to web portal 102.

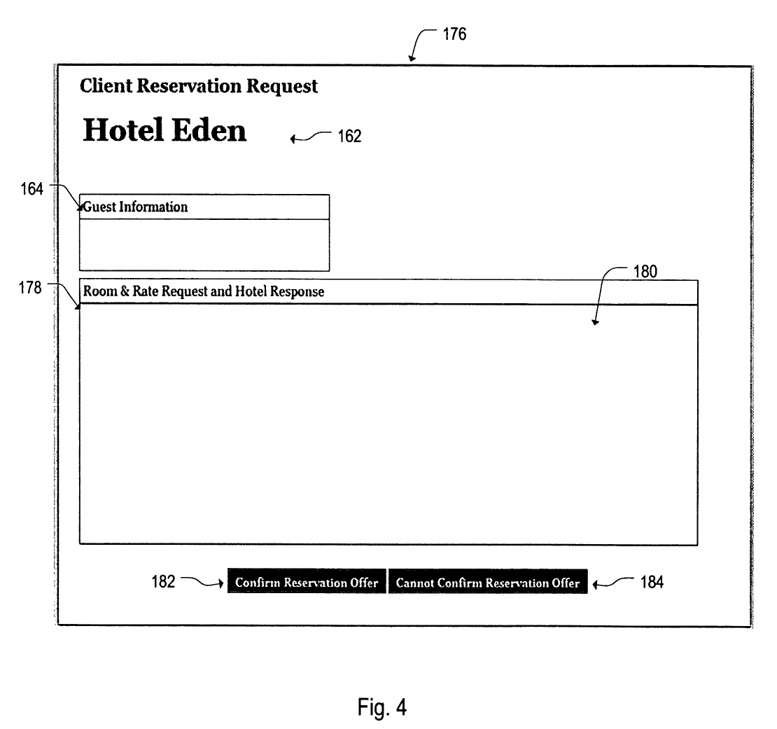

FIG. 4 is an illustration of a client reservation request page 176 that second users 106 may receive from web portal 102. Specifically, second users 106 may use client reservation request page 176 to confirm or deny the first user's 104 reservation request. In the exemplary embodiment, client reservation request page 176 may include client information box 164, a service request area 178 and a service provider response area 180. Moreover, request page 176 may include a confirm reservation offer button 182 and a cannot confirm reservation offer button 184. Moreover, the information contained within client information box 164 may be fixed such that the information may not be edited by second users 106. Service provider response area 180 may be edited by second users 106. Specifically, second users 106 may indicate whether the requested service is available, the type of service available, the dates the service is available and an offered service rate. Confirm reservation offer button 182 enables second users 106 to send a confirmation of the reservation request to first users 104 via web portal 102. Moreover, cannot confirm reservation button 184 enables second users 106 to notify first users 104 via web portal 102 that the reservation request cannot be confirmed.

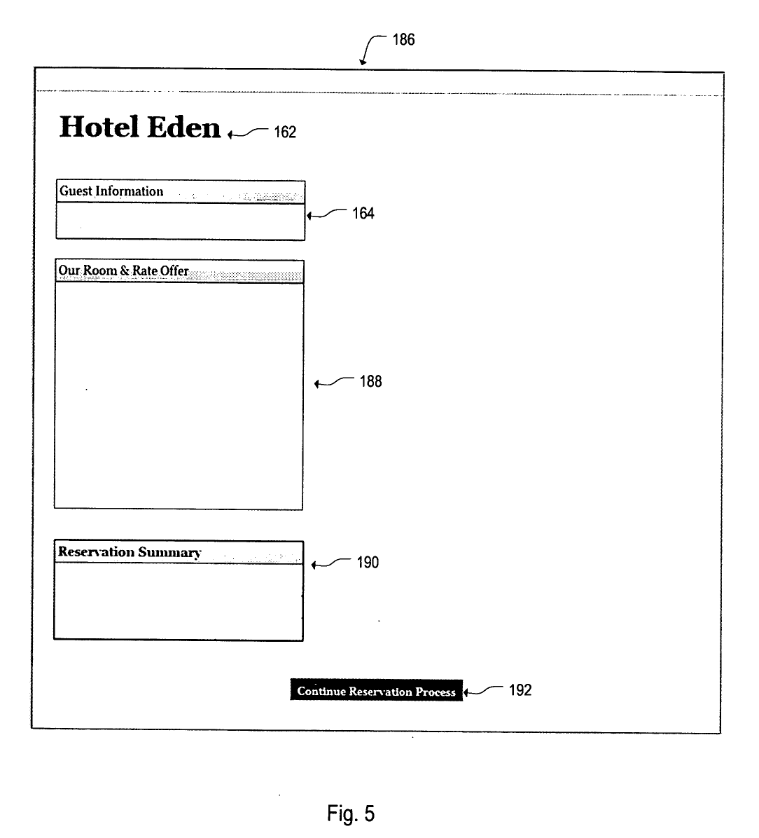

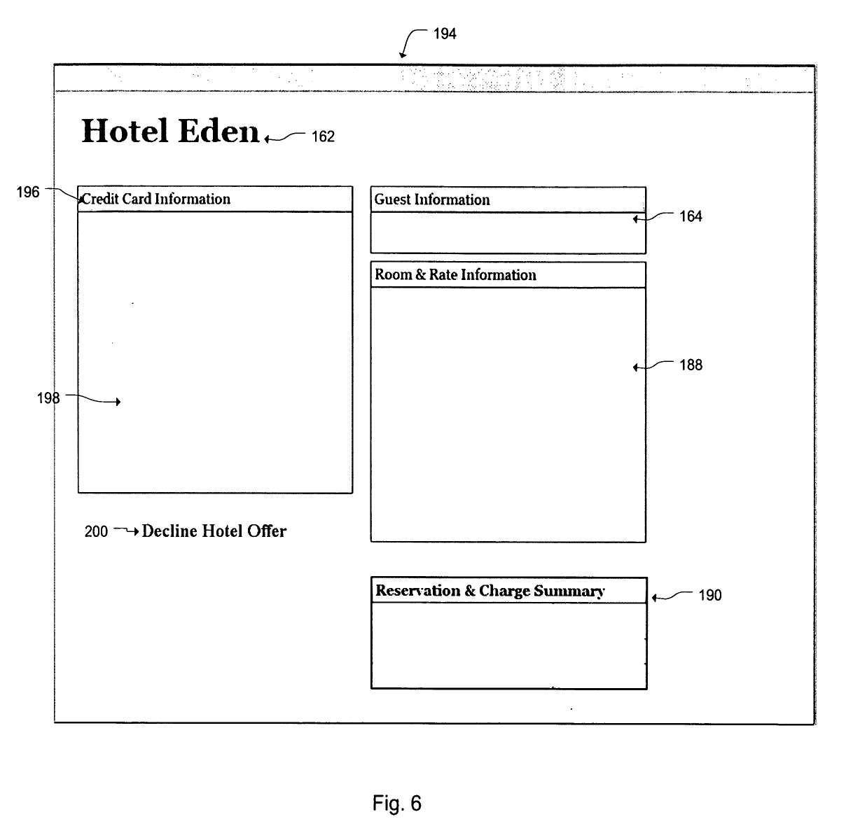

FIG. 5 is an illustration of a service and rate offer page 186. Specifically, first users 104 may use service and rate offer page 186 to accept and confirm a service rate offer from second users 106. In the exemplary embodiment, service and rate offer page 186 may include client information box 164, service provider name 162, a service and rate offer box 188, a reservation summary box 190 and a continue reservation button 192. Service and rate offer box 188 may include a detailed description of the service offer extended to first users 104 by second users 106. In one embodiment, service and rate offer box 188 may include, but not limited to, the type of service and/or the desired duration of the service. In another embodiment, service and offer rate box 188 may include, but not limited to, an arrival date, a departure date, the number of adults, the number of children and a comment box. In the exemplary embodiment, reservation summary box 190 may include a breakdown of the cost associated with the service offer. In one embodiment, the cost may be expressed in a specific country's currency. In an alternative embodiment, the cost may be converted or displayed in any country's currency that first users 104 may prefer. In another alternative embodiment, the cost may be automatically displayed in the currency of the country in which a specific first user 104 is located. Continue reservation button 192 enables first users 104 to continue to a payment page 194, as shown in FIG. 6 and as described in more detail below.

FIG. 6 is an illustration of payment page 194. Specifically, first users 104 may use payment page 194 to pay for the services offered by second users 106 using web portal 102. In the exemplary embodiment, payment page 194 may include service provider name 162, client information box 164, service and rate information box 148, reservation summary box 190 and a payment information box 196. In the exemplary embodiment, payment information box 196 may be used to submit credit card information to web portal 102 for payment processing. In another embodiment, payment information box 196 may include, but not limited to, wire transfers, account drafts, gift cards, coupons and/or any type of payment that enables system 100 to function as described herein. Moreover, payment page 194 may include a confirm reservation button 198 and a decline service provider offer link 200. Specifically, confirm reservation button 198 enables first users 104 to confirm reservation and remit payment for the reservation to second users 106 via web portal 102. Decline service provider offer link 200 enables first users 104 to notify second users 106 via web portal 102 that the reservation offer has been declined.

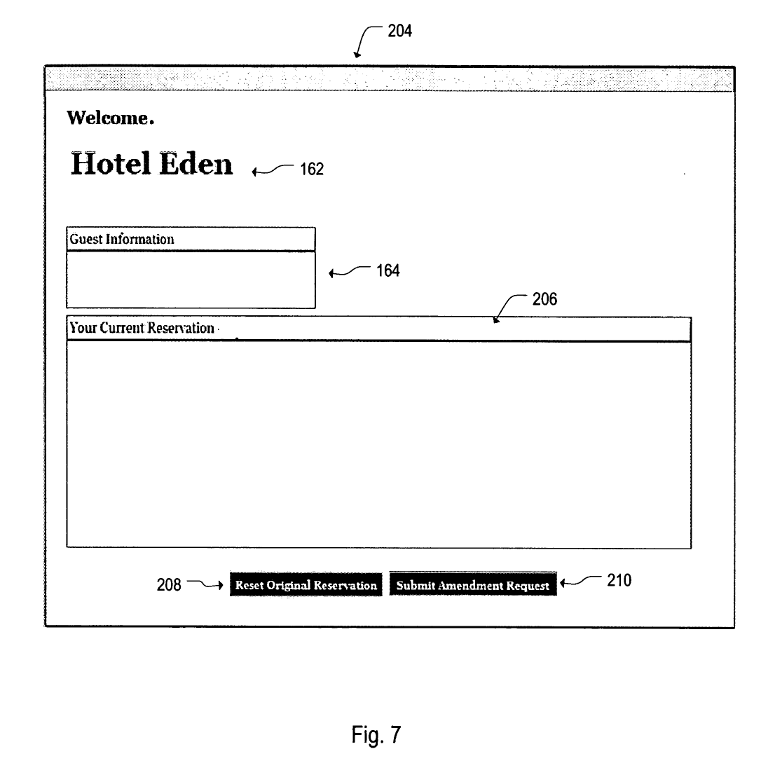

FIG. 7 is an illustration of a reservation amendment page 204. Specifically, first users 104 may use amendment page 204 to submit reservation amendment requests to second users 106 via web portal 102. In the exemplary embodiment, amendment page 204 may include service provider name 162, client information box 164 and a current reservation information box 206, which may display the current reservation information that the first user 104 has reserved. Moreover, amendment page 204 may also include a reset original reservation button 208 and a submit amendment request button 210. Current reservation information box 206 may be edited by first users 104 to facilitate amending the current reservation, as described in more detail below. Reset original reservation button 208 enables first users 104 to clear any changes that have been made to the current reservation within current reservation information box 206. Moreover, submit amendment request button 210 enables first users 104 to submit their amended request to second users 106 via web portal 102.

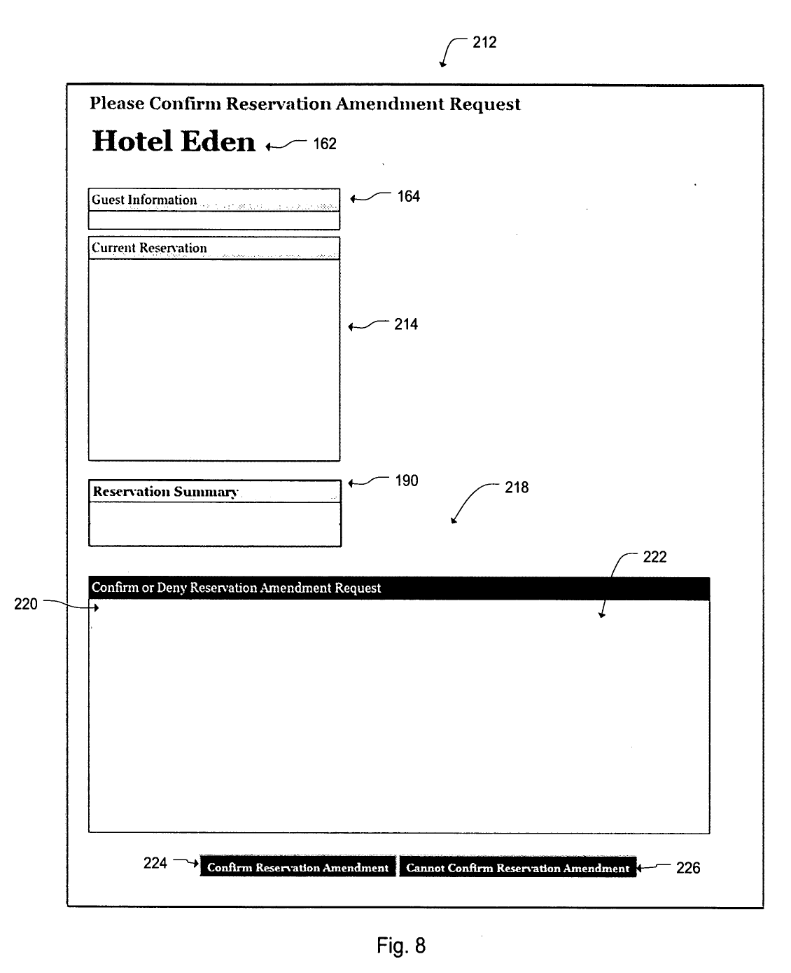

FIG. 8 is an illustration of a client reservation amendment request page 212 that second users 106 may receive from first users 104 via web portal 102. Specifically, second users 106 may use client reservation amendment request page 212 to confirm or deny the first user's 104 amendment request. In the exemplary embodiment, client reservation amendment request page 212 may include client information box 164, a current reservation information box 214, reservation summary box 190 and a confirm or deny amendment box 218. Confirm or deny amendment box 218 may include a client amendment request information 220 and a service provider response area 222. In the exemplary embodiment, client amendment request information 220 may be fixed such that information contained therein may not be edited by second users 106. Moreover, service provider response area 222 may be editable to enable second users 106 to respond to the amendment request. Specifically, response area 222 enables second users 106 to indicate whether the requested amendment is available, the type of service available and an amended service rate. Moreover, client reservation amendment request page 212 may include a confirm reservation amendment button 224 and a cannot confirm reservation amendment button 226. Confirm reservation amendment button 224 enables second users 106 to send a confirmation of the amendment request to first users 104 via web portal 102. Moreover, cannot confirm reservation amendment button 226 enables second users 106 to notify first users 104 via web portal 102 that the amendment request cannot be confirmed.

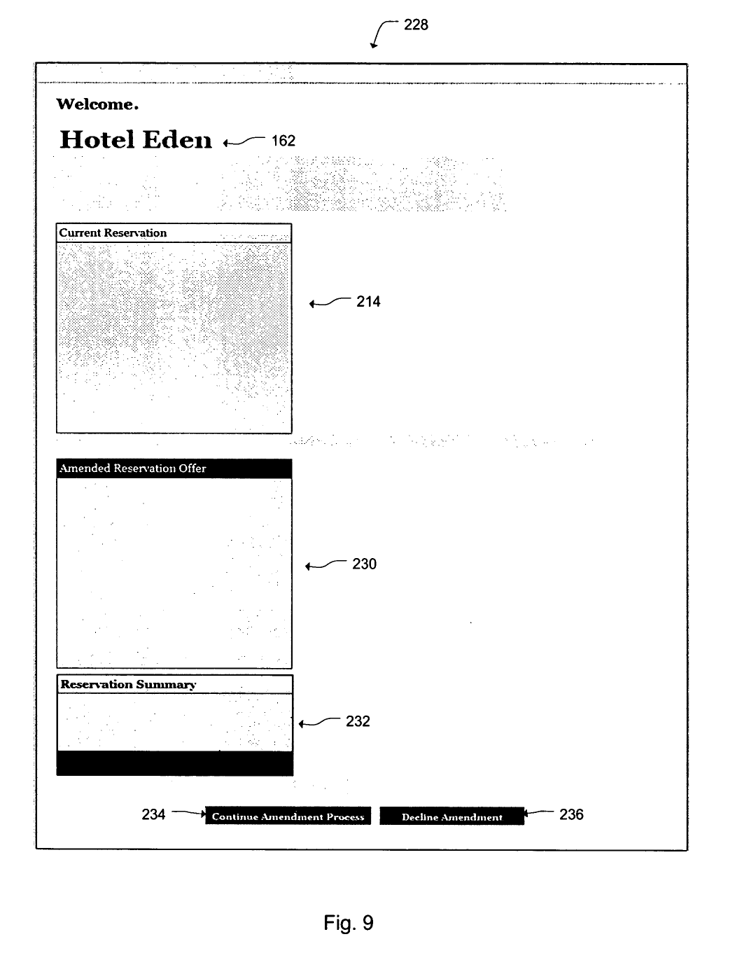

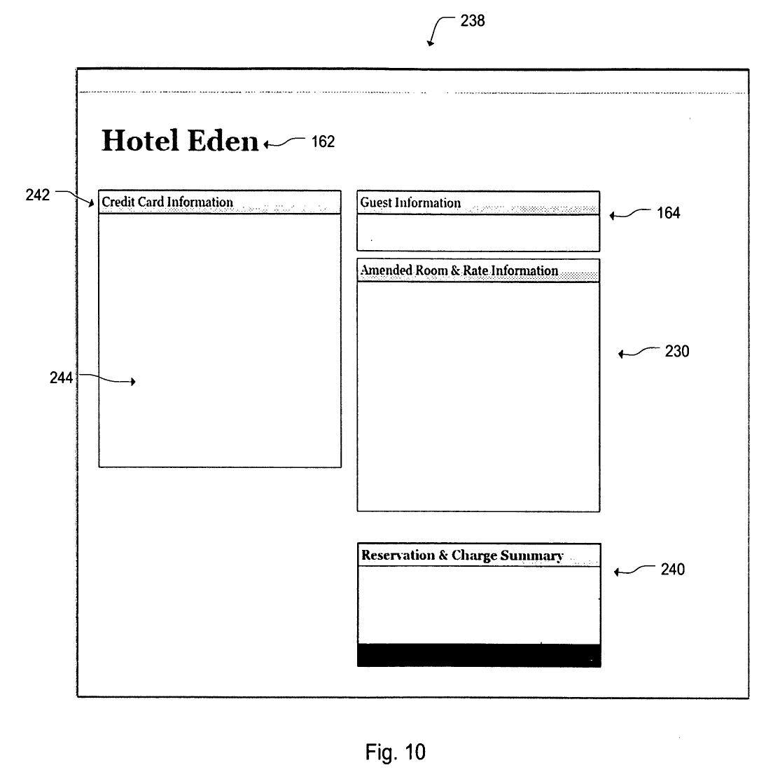

FIG. 9 is an illustration of an amendment offer page 228. Specifically, first users 104 may use amendment offer page 228 to accept and confirm the amendment offer from second users 106. In the exemplary embodiment, amendment offer page 228 may include service provider name 162, current reservation information box 214, a amended reservation offer box 230, a amendment reservation summary box 232, a continue amendment button 234 and a decline amendment button 236. Amendment reservation offer box 230 may include a detailed description of the amended offer from second users 106. Moreover, in the exemplary embodiment, amendment reservation summary box 232 may include the original reservation cost, the cost of the amended reservation and the difference between the two. As a result, amendment reservation summary box 232 facilitates displaying how much money is owed to either the first user 104 or the second user 106. Continue amendment button 234 enables first users 104 to continue to an amendment confirmation and settlement page 238, as shown in FIG. 10. Decline amendment button 236 facilitates notifying second users 106 that first users 104 decline the amendment offer, as described in more detail below.

FIG. 10 is an illustration of an amendment confirmation and settlement page 238. Specifically, first users 104 may use amendment confirmation and settlement page 238 to pay the difference between the original reservation and the agreed-to amended reservation amount. In an alternative embodiment, first users 104 may be entitled to a partial refund in the event the cost of the amended reservation is less that the cost of the original reservation. In the exemplary embodiment, amendment confirmation and settlement page 238 may include service provider name 162, client information box 164, amended service information box 230, a reservation and charge summary box 240 and a payment information box 242. In the exemplary embodiment, payment information box 242 may be used to submit credit card information to web portal 102 for payment processing. In another embodiment, payment information box 242 may include, but not limited to, wire transfers, account drafts, gift cards, coupons and/or any type of payment that enables system 100 to function as described herein. Moreover, amendment confirmation and settlement page 238 may include a confirm reservation button 244. Specifically, confirm reservation button 244 enables first users 104 to confirm reservation and remit a payment to or receive a refund from second users 106 for the amended reservation via web portal 102.

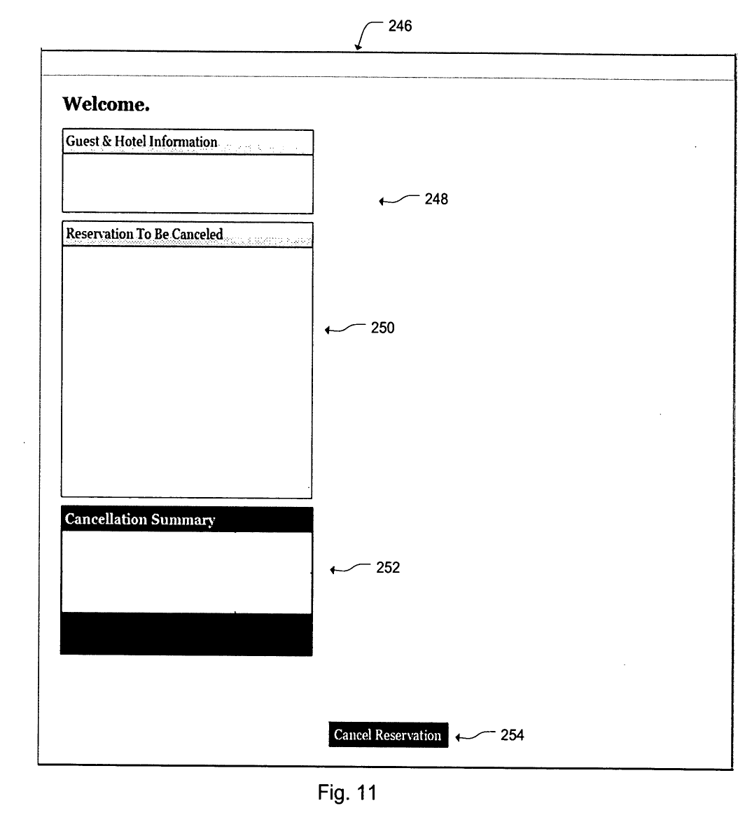

FIG. 11 is an illustration of a cancellation page 246. Specifically, first users 104 may use cancellation page 246 to facilitate cancelling their reservation with second users 106 via web portal 102. In the exemplary embodiment, cancellation page 246 may include a client and service provider information box 248, a reservation information box 250, a reservation cancellation summary box 252 and a cancel reservation button 254. Client and service provider information box 248 may include client information and the respective service provider associated with the reservation. Cancellation summary box 252 may display the amount that will be refunded to first users 104. Cancellation button 254 enables first users 104 to submit a reservation cancellation to second users 106 via web portal 102, as described in more detail below.

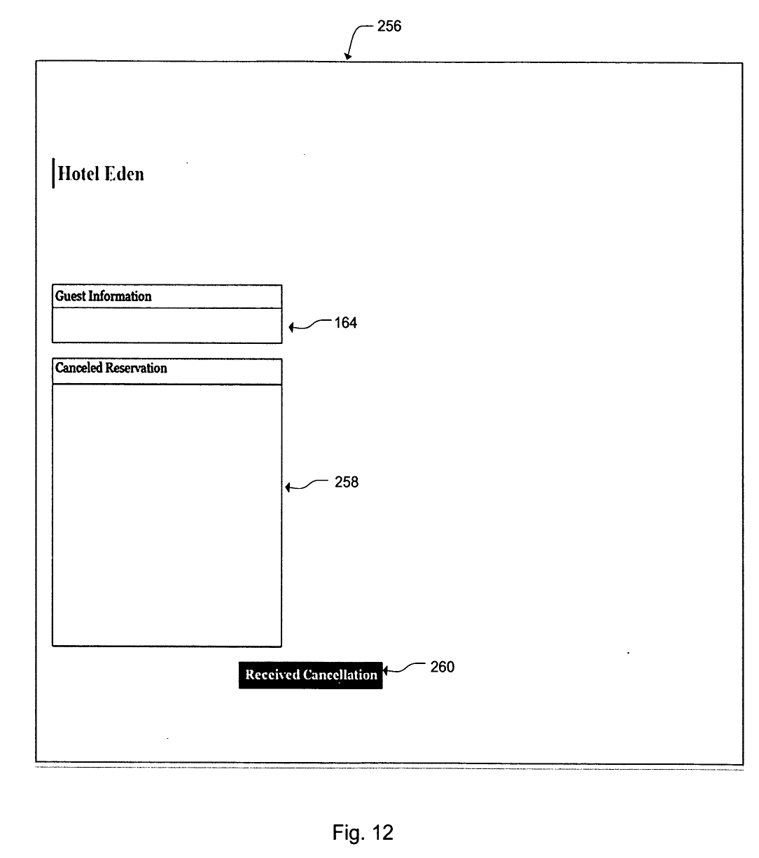

FIG. 12 is an illustration of a reservation cancellation confirmation page 256. Specifically, second users 106 use reservation cancellation confirmation page 256 to confirm that the reservation has been received and cancelled, as described in more detail below. In the exemplary embodiment, reservation cancellation confirmation page 256 may include client information box 164, a cancelled reservation box 258 and a received cancellation button 260. Reservation cancellation button 260 enables second users 106 to confirm that the cancellation notification has been received.

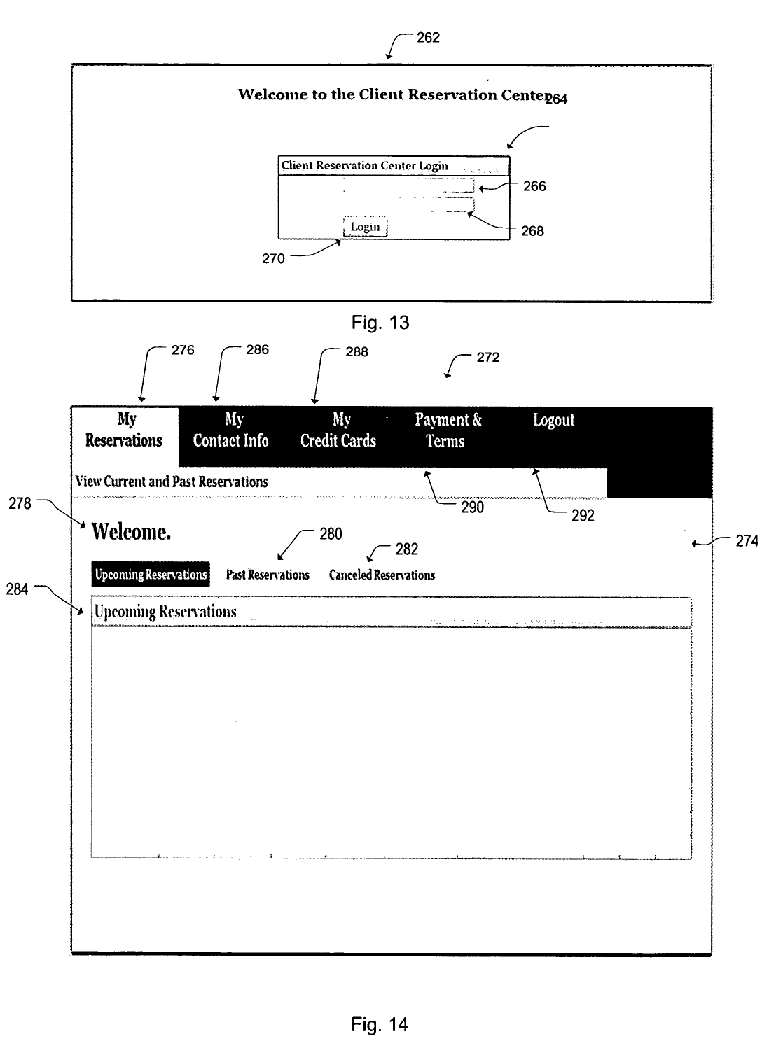

FIG. 13 is an illustration of a client reservation center login page 262. Specifically, first users 104 may register with web portal 102 to obtain a user name and password. In the exemplary embodiment, client reservation center login page 262 may include a login box 264 that includes a username entry field 266, a password entry field 268 and a login button 270. In the exemplary embodiment, registered first users 104 may sign-in to a client reservation center 272 (shown in FIG. 14), which facilitates managing first users 104 reservations.

FIG. 14 is an illustration of a client reservation page 274 within client reservation center 272. Specifically, first users 104 may navigate to client reservation center 272 by submitting login information on client reservation center login page 262, as shown in FIG. 13. Client reservation center 272 facilitates tracking all the reservations made by first users 104. Specifically, center 272 may include a plurality of tabs that facilitate navigating first users 104 to various pages within client reservation center 272, as described in more detail below. In the exemplary embodiment, center 272 may include a reservations tab 276 that navigates first users 104 to client reservation page 274, which may include an upcoming reservation link 278, a past reservation link 280 and a cancelled reservation link 282. Upcoming reservation link 278 enables first users 104 to view the upcoming reservations they have reserved. Moreover, first users 104 may view, amend or cancel any of their current reservations that have been confirmed by second users 106. Past reservations link 280 enables first users 104 to view the past reservations first users 104 have reserved. Further, cancelled reservations link 282 enables first users 104 to view their cancelled reservations.

In the exemplary embodiment, client reservation center 272 may also include a contact information tab 286 that facilitates navigating first users 104 to a client contact information page (not shown). First users 104 may enter and/or update their contact information on the client contact information page. Moreover, center 272 may also include a credit card tab 288 that facilitates navigating first users 104 to a payment page (not shown). In the exemplary embodiment, the payment page may include credit card information to enable first users 104 to pay second users 106 for a reservation. Alternatively, the payment page may include, but not limited to, bank account information and/or any other type of payment method that enables system 100 to function as described herein. Moreover, center 272 may also include a payment and terms tab 290 that may navigate first users 104 to a payment and terms page (not shown). The payment and terms page may include the payment policies, cancellation policies and/or any other policies of system 100 published thereon. Further, center 272 may also include a logout tab 292 that enables first users 104 to logout of center 272.

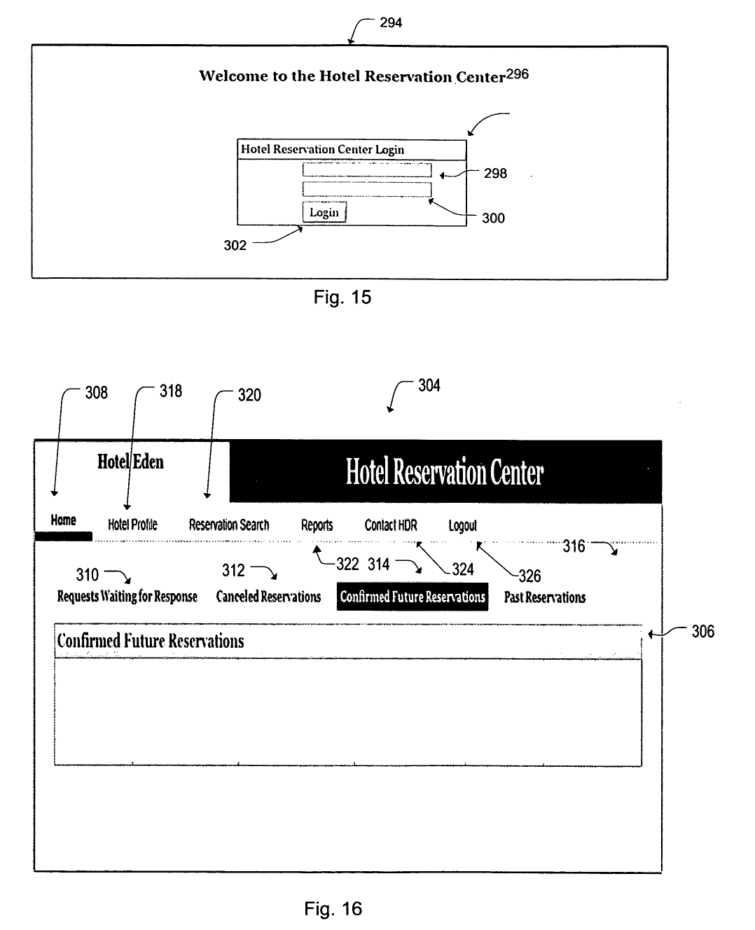

FIG. 15 is an illustration of a service provider reservation center login page 294. Specifically, second users 106 may register with web portal 102 to obtain a user name and password. In the exemplary embodiment, service provider reservation center login page 294 may include a login box 296 that includes a username entry field 298, a password entry field 300 and a login button 302. In the exemplary embodiment, registered second users 106 may sign-in to a service provider reservation center 304 (shown in FIG. 16), which facilitates managing second users 106 reservations.

FIG. 16 is an illustration of a service provider home page 306 within service provider reservation center 304. Specifically, second users 106 may navigate to service provider reservation center 304 by submitting login information on service provider reservation center login page 294, as shown in FIG. 15. Service provider reservation center 304 facilitates tracking all the reservations submitted to second users 106 by first users 104 via web portal 102. Specifically, center 304 may include a plurality of tabs that facilitate navigating second users 106 to various pages within service provider reservation center 304, as described in more detail below. In the exemplary embodiment, center 304 may include a home tab 308 that navigates second users 106 to home page 306, which may include a requests waiting for response link 310, a cancelled reservations link 312, a confirmed future reservations link 314 and a past reservations link 316. Requests waiting for response link 310 enables second users 106 to view the reservation requests sent to second users 106 by first users 104 via web portal 102. Cancelled reservations link 312 enables second users 106 to view the reservations that have been cancelled by first users 104. Confirmed future reservations link 314 enables second users 106 to view the reservations that have been confirmed by first users 104. Past reservations link 316 enables second users 106 to view the past reservations that have been fulfilled.

In the exemplary embodiment, service provider reservation center 304 may also include a service provider profile tab 318 that facilitates navigating second users 106 to a service provider profile page (not shown) where second users 106 may enter and/or update their profile. Moreover, center 304 may also include a reservation search tab 320 that enables second users to search their reservations. Center 304 may also include a reports tab 322 that enables second users 106 to view various reports that may be generated by center 304. Moreover, center 304 may include a contact tab 324 that enables second users 106 to contact a customer service representative at web portal 102. Further, center 304 may also include a logout tab 326 that enables second users 106 to logout of center 304.

Although system 100 may be used to reserve any type of service, a non-limiting example pertaining to reserving a hotel room is used to describe the operation of system 100. In this non-limiting example, at least one first user 104, or guest, contacts at least one second user 106, or hotel via web portal 102 such that the guest and the hotel may privately interact with each other using web portal 102. Specifically, web portal 102 may be the primary source of contact for both the guest and the hotel, during the transaction. As a result, system 100 facilitates eliminating third party re-sellers of services and enables the guest and the hotel to interact together through web portal 102.

During operation, in the non-limiting example, the guest may access web portal 102 by clicking on a reservation link (not shown) that may be placed on a hotel's website (not shown). Alternatively, the guest may access web portal 102 by navigating a web browser to the internet address of web portal 102. In yet another embodiment, the guest may access web portal 102 using any other known connection methods that enable system 100 to function as described herein. Once the guest clicks on the link, the guest may be directed to reservation request page 160, as shown in FIG. 3. The guest may then enter their contact information into client information box 164 and their desired room information within service information box 166 located on reservation request page 160. In the exemplary embodiment, the guest may enter the type of room, the number of adults and children that will be in the room, the duration of the stay and any special requests they may have. In another embodiment, service information page 160 may include requests for specific floor locations, room service, food and beverages and/or any other room attribute request. Once the guest has entered the information, the guest may click submit button 168, to facilitate sending the information to web portal 102.

In the non-limiting hotel reservation example, once the guest clicks submit button 168, the guest is directed to a webpage (not shown) that confirms that the request has been submitted to the appropriate hotel. Moreover, once the guest clicks submit button 168, the guest and the hotel are establish a direct connection with each other via web portal 102 to facilitate providing a platform to conduct business transactions. In one embodiment, the direct connection is substantially private. In another embodiment, the direct connection between the guest and the hotel enables web portal 102 to be the identifiable source of contact between the guest and hotel. In yet another embodiment, the direct connection may be free from interference from, but not limited to, a service broker, pre-determined contractual agreements, pricing limitations, publically revealed service pricing and/or any other third parties reselling services to consumers.

In one embodiment, the webpage that confirms that the request has been submitted may also include a unique username (not shown) and password (not shown) that enables the guest to logon to client reservation center 272, as shown in FIG. 14, to facilitate tracking and managing their reservations. In the exemplary embodiment, after the guest clicks submit button 168 and once the hotel receives the request, web portal 102 generates and sends an email (not shown) to both the guest and the hotel indicating that the hotel has received a room request. In one embodiment, the email to the guest may also include the unique username and password, as described above. In another embodiment, the email sent to the hotel includes a link that enables the hotel to navigate to client reservation request page 176, as shown in FIG. 4. In yet another embodiment, web portal 102 may contact the hotel using an instant message, a phone call, a text and/or any other form of communication that enable system 100 to function as described herein. In yet another embodiment, the hotel may receive an email indicating that a guest submitted a room request, wherein the email does not include the guest's personal information such that the guest's identity is concealed from the hotel. As a result, in such an embodiment, the guest and the hotel may transact business anonymously.

Once the hotel receives notice that the guest has requested a reservation, the hotel may access client reservation request page 176 to facilitate responding to the request. Moreover, once the hotel has accessed client reservation request page 176, web portal 102 generates and sends an email (not shown) to the guest indicating that their reservation request has been received by the hotel. In one embodiment, the hotel may access client reservation request page using service provider reservation center 304, as shown in FIG. 16. In one embodiment, web portal 102 may require the hotel to respond to the request within a specific amount of time. In the non-limiting hotel example, web portal 102 may require the hotel to respond within twenty-four hours of receiving the guest's request. The hotel may respond to the guest reservation request by filing in the appropriate information within service provider response area 180. Specifically, the hotel may indicate whether a room is available, the type of room available and the rate of the available room. As shown in FIG. 4, the hotel may then click confirm reservation offer button 182 to facilitate sending the offer to the guest via web portal 102. As a result, the hotel has the freedom to choose to offer the guest a room rate based on real-time business factors such as, but not limited to, room occupancy and/or the demand for rooms in that hotel. Thus, the hotel is not bound to accept previously contracted rates for rooms. In the event no rooms are available, the hotel may click cannot confirm reservation offer button 184 to facilitate indicating to the guest that no rooms are available.

In the non-limiting hotel reservation example, once the hotel clicks confirm reservation offer button 182, the reservation offer information is sent to web portal 102. Web portal 102 then directs the hotel to a reservation offer sent webpage (not shown) that indicates to the hotel that web portal 102 has sent the offer to the guest. Moreover, web portal 102 also generates and sends a room and rate confirmation email (not shown) to the guest notifying the guest that the hotel has responded with an offer that may be guaranteed for a certain amount of time. In one embodiment, the offer may be guaranteed for two days. In another embodiment, the offer may be guaranteed for any amount of time that enables system 100 to function as described herein. In yet another embodiment, the room and rate confirmation email may include a link therein that may connect the guest to client reservation center 272 to enable the guest to review the hotel's offer.

The guest may review the hotel's offer on the service and rate offer page 186, as shown in FIG. 5. Specifically, the guest may review the offer details in service and rate offer box 188. Moreover, the guest may review the cost of the room in reservation summary box 190. In the event the guest wishes to accept the hotel's offer, the guest may click on continue reservation process button 192, which may direct the guest to payment page 194, as shown in FIG. 5. In one embodiment, in the event the guest does not click on continue reservation button 192, web portal 102 may periodically send the guest reminder emails until the guest either clicks button 192 or the offer's time period expires.

In the non-limiting hotel example, payment page 194 enables the guest to confirm their reservation and remit payment for the reservation. Specifically, in the event the guest wishes to accept the offer, the guest may enter their payment information into payment information box 196. In one embodiment, payment page 194 may be encrypted to ensure security of the information entered into payment page 194. Once the guest has entered their payment information, the guest may click confirm reservation button 198, which facilitates submitting the confirmation and payment information to web portal 102. In one embodiment, web portal 102 may deduct a commission from the payment sent to the hotel. In such an embodiment, the commission may be a percentage of the payment. Moreover, in such an embodiment, the commission may be an amount that the hotel has previously agreed to.

Once the guest clicks button 192, the guest is directed to a hotel reservation confirmation webpage (not shown) that confirms that the reservation has been booked and paid for. In one embodiment, the hotel reservation confirmation webpage may be used as a receipt of payment and for hotel check-in. Moreover, once the guest clicks confirm reservation button 198, web portal 102 may also generate and send a confirmation email (not shown) to both the guest and the hotel indicating that the guest has accepted the hotel's offer. If however, the guest decides not to accept the hotel's offer, the guest may click decline service provider offer link 200, which facilitates notifying the hotel via web portal 102 that the guest has declined the offer. As a result, the hotel may release the room from hold such that another guest may reserve the room.

After the guest has confirmed and paid for the reservation but before the start of the actual service, the guest may need to change or amend their reservation. In such an event, the guest may access web portal 102 by clicking on a reservation link that may be placed on the hotel's website. In an alternative embodiment, the guest may access web portal 102 by navigating a web browser to the internet address of web portal 102. In another embodiment, the guest may login to client reservation center 272 using the client reservation center login page 262, as shown in FIG. 13. In yet another embodiment, the guest may access web portal 102 using any other known connection methods that enable system 100 to function as described herein. Once the guest clicks on the link, the guest may be directed to reservation amendment page 204, as shown in FIG. 7. Reservation amendment page 204 may display the current reservation details in current reservation information box 206. The guest may edit the information within current reservation information box 206 to reflect the desired reservation changes. In the exemplary embodiment, the guest may amend the type of room, the number of adults and children that will be in the room, the duration of the stay and any special requests the guest may have. In another embodiment, current reservation information box 206 may include requests for specific floor locations, room service, food and beverages and/or any other room attribute request. Once the guest has amended the information, the guest may click submit amendment request button 210, to facilitate sending the information to web portal 102. In the event the guest wishes remove any amendments they may have made to reservation amendment page 204, the guest may click reset original reservation button 208.

In the non-limiting hotel reservation example, once the guest clicks submit amendment request button 210, the guest is directed to a view amendment request webpage (not shown) that displays the amendment request that has been submitted to the appropriate hotel. In one embodiment, the webpage may also include the original reservation request. Moreover, after the guest clicks submit amendment request button 210 and once the hotel receives the request, web portal 102 generates and sends an email (not shown) to both the guest and the hotel indicating that the hotel has received an amendment request. In one embodiment, the email sent to the hotel includes a link that enables the hotel to navigate to client reservation amendment request page 212, as shown in FIG. 8. In another embodiment, web portal 102 may contact the hotel using an instant message, a phone call, a text and/or any other form of communication that enable system 100 to function as described herein. Once the hotel has accessed client reservation amendment request page 212, web portal 102 generates and sends an email (not shown) to the guest indicating that their reservation amendment request has been received by the hotel.

Once the hotel receives notice that the guest has submitted a reservation amendment, the hotel may access client reservation amendment request page 212 to facilitate responding to the request. In one embodiment, the hotel may access the client reservation amendment request page 204 using service provider reservation center 304, as shown in FIG. 16. In one embodiment, web portal 102 may require the hotel to respond to the request within a specific amount of time. The hotel may respond to the guest reservation amendment request by filing in the appropriate information within confirm or deny amendment box 218. Specifically, the hotel may indicate whether a room is available, the type of room available and the rate of the available room. As shown in FIG. 8, the hotel may then click confirm reservation amendment button 224 to facilitate sending the amendment offer to the guest via web portal 102. As a result, the hotel has the freedom to choose to offer the guest a room rate based on real-time business factors such as, but not limited to, room occupancy and/or the demand for rooms in that hotel. Thus, the hotel is not bound to accept previously contracted rates for rooms. In the event no rooms are available for the amendment, the hotel may click cannot confirm reservation amendment button 226 to facilitate notifying the guest that the hotel cannot accommodate the guest's requested amendment.

In the non-limiting hotel reservation example, once the hotel clicks confirm reservation amendment button 224, the reservation amendment information is sent to web portal 102. Web portal 102 then directs the hotel to a reservation amendment sent webpage (not shown) that indicates to the hotel that web portal 102 has sent the amendment offer to the guest. Moreover, web portal 102 also generates and sends a room and rate confirmation email (not shown) to the guest notifying the guest that the hotel has responded with an amendment offer that may be guaranteed for a certain amount of time. In one embodiment, the offer may be guaranteed for two days. In another embodiment, the offer may be guaranteed for any amount of time that enable system 100 to function as described herein. In yet another embodiment, the room and rate confirmation email may include a link therein that may connect the guest to client reservation center 272 to enable the guest to review the hotel's amendment offer.

The guest may review the hotel's amendment offer on the amendment offer page 228, as shown in FIG. 9. Specifically, the guest may review the amendment offer details in amendment reservation offer box 230. Moreover, the guest may review the cost of the amendment offer in amendment reservation summary box 232. In the event the guest wishes to accept the hotel's amendment offer, the guest may click on continue amendment process button 234, which may direct the guest to amendment confirmation and settlement page 238, as shown in FIG. 10. In one embodiment, in the event the guest does not click on continue amendment button 234, web portal 102 may periodically send the guest reminder emails until the guest either clicks button 234 or the amendment offer's time period expires. In the event the guest wishes to decline the hotel's amendment offer, the guest may click decline amendment button 236, which facilitates notifying the hotel via web portal 102 that the guest has declined the amendment offer. As a result, the hotel may release the room from hold such that another guest may reserve the room.

In the non-limiting hotel example, amendment confirmation and settlement page 238 enables the guest to confirm their amendment reservation and remit or receive funds for the amended reservation. Specifically, in the event the amended reservation is more expensive that the original reservation, the guest may enter their payment information into payment information box 242. In one embodiment, amendment confirmation and settlement page 238 may be encrypted to ensure security of the information entered into payment information box 242. Once the guest has entered their payment information, the guest may click confirm reservation button 244, which facilitates submitting the confirmation and payment information to web portal 102. In the event the amended reservation is less than the original reservation, the guest may enter their payment information to receive a refund of the difference. Furthermore, once the guest clicks confirm reservation button 244, the guest is directed to a hotel amended reservation confirmation webpage (not shown) that confirms that the reservation has been booked and paid for. In one embodiment, the hotel amended reservation confirmation webpage may be used as a receipt of payment and for hotel check-in. Moreover, once the guest clicks confirm reservation button 244, web portal 102 may also generate and send a confirmation email (not shown) to both the guest and the hotel indicating that the guest has accepted the hotel's amendment offer.

After the guest has confirmed and paid for the reservation but before the start of the actual service, the guest may need to cancel their reservation. In such an event, the guest may access web portal 102 by clicking on a reservation link that may be placed on the hotel's website. In an alternative embodiment, the guest may access web portal 102 by navigating a web browser to the internet address of web portal 102. In another embodiment, the guest may login to client reservation center 272 using the client reservation center login page 262, as shown in FIG. 13. In yet another embodiment, the guest may access web portal 102 using any other known connection methods that enable system 100 to function as described herein. Once the guest clicks on the link, the guest may be directed to cancellation page 246, as shown in FIG. 11. Cancellation page 246 may display the current reservation details in reservation information box 250. Moreover, cancellation page 246 may also includes reservation cancellation summary box 252 that may display the amount that may be refunded to the guest. Once the guest has decided to cancel the reservation, the guest may click cancel reservation button 254, to facilitate sending the cancellation request to web portal 102.

In the non-limiting hotel reservation example, once the guest clicks cancel reservation button 254, the guest is directed to a view cancelled reservation webpage (not shown) that displays the cancelled reservation that has been submitted to the appropriate hotel. Moreover, after the guest clicks cancel reservation button 254 and the hotel receives the request, web portal 102 generates and sends an email (not shown) to both the guest and the hotel indicating that the hotel has received the cancellation request. In one embodiment, the email sent to the hotel includes a link that enables the hotel to receive the cancellation request to facilitate confirming the cancellation of the reservation. In another embodiment, web portal 102 may contact the hotel using an instant message, a phone call, a text and/or any other form of communication that enable system 100 to function as described herein.

As discussed in the embodiments above, system 100 enables a service provider to directly connect with a consumer to facilitate eliminating a service broker that may be positioned between the service provider and the consumer. The consumer may request a service offer from the service provider and the service provider may offer their services at a price that is freely determined without regard to the service broker. In one embodiment, the service provider may freely determined the price of the service free from interference from, but not limited to, a service broker, pre-determined contractual agreements, pricing limitations, publically revealed service pricing and/or any other third parties reselling services to consumers. As a result, the service provider may offer their services at prices that enable the service provider to increase profits during a time of high demand for the services. Moreover, system 100 enables the service provider to offer their services at prices that enable the service provider to minimize loses during a period of low demand for the services. Thus, system 100 enables service providers to adjust the prices of their services more effectively in light of the day-to-day demands of the consumers as compared to service providers that contract their services out to service brokers for a fix and/or pre-determined price.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method of connecting at least one consumer with at least one service provider, said method comprising:
connecting at least one consumer and at least one service provider to a web portal, wherein the at least one consumer is seeking a service and the at least one service provider provides the service;
establishing a direct communication connection between the at least one consumer and the at least one service provider using the web portal to facilitate providing a platform to conduct business transactions such that the direct communication connection is substantially private, wherein the direct communication connection is relayed through the web portal; and
transacting business between the at least one consumer and the at least one service provider using the web portal such that the at least one service provider sells the service to the at least one consumer directly.

2. A method in accordance with claim I wherein establishing a direct communication connection between the at least one consumer and the at least one service provider using the web portal further comprises:
sending, by the at least one consumer to the at least one service provider using the web portal, a service offer request for the service performed by the at least one service provider; and
sending, by the at least one service provider to the at least one consumer using the web portal, a service offer that includes at least one of a service description, a service price and a service duration, wherein the service price is freely determined by the at least one service provider.

3. A method in accordance with claim I wherein transacting business between the at least one consumer and the at least one service provider using the web portal further comprises:
confirming, by the at least one consumer, a service offer sent by the at least one service provider using the web portal;
remitting a payment by the at least one consumer to the at least one service provider using the web portal, such that the at least one consumer remits the payment to the web portal and the web portal remits the payment to the at least one service provider.
performing, by the at least one service provider for the at least one consumer, the service.

4. A method in accordance with claim 3 further comprises deducting a commission on the payment remitted to the at least one service provider from the web portal, wherein the commission is a percentage of the payment remitted to the at least one service provider.

5. A method in accordance with claim 3 further comprises:
sending, by the at least one consumer to the at least one service provider using the web portal, an amendment to the confirmed service offer; and
providing, by the at least one service provider to the at least one consumer using the web portal, a confirmation of the amendment.

6. A method in accordance with claim 1 further comprising cancelling the business transaction between the at least one consumer and the at least one service provider using the web portal, wherein the at least one consumer sends a cancellation request to the at least one service provider.

7. A method in accordance with claim 1 wherein transacting business between the at least one consumer and the at least one service provider using the web portal further comprises remitting, by the at least one service provider to the web portal, a refund payment, wherein the web portal remits the refund payment to the at least one consumer.

8. A method in accordance with claim 1 wherein the at least one service provider provides services that include at least one of a lodging service, a travel service and an event service.

9. A method in accordance with claim 1 wherein the service includes at least one of a lodging reservation, a travel reservation and an event reservation.

10. A computer program embodied on a computer-readable medium, said computer program comprising at least one code segment configured to instruct a computer to:
connect a consumer and a service provider to a web portal to facilitate establishing a direct communication connection between the consumer and the service provider, wherein the consumer is seeking a service and the service provider provides the service;
send a service offer request from the consumer to the service provider, said service offer request comprises an offer request for a service performed by the service provider;
send a service offer from the service provider to the consumer, said service offer comprises at least one of a service description, a service price and a service duration;
send a confirmation of the service offer from the consumer to the service provider, wherein said confirmation comprises an acceptance of said service offer; and
remit a payment from the consumer to the service provider for the service provided by the service provider.

11. A computer program in accordance with claim 10 wherein said computer program further comprises at least one code segment configured to deduct a commission on said payment remitted to the service provider, wherein said commission is a percentage of said payment remitted to the service provider.

12. A computer program in accordance with claim 10 wherein said computer program further comprises at least one code segment configured to:
send an amendment to the confirmed service offer from the consumer to the service provider; and
send a confirmation of said amendment from the service provider to the consumer.

13. A computer program in accordance with claim 10 wherein said computer program further comprises at least one code segment configured to send a cancellation request from the consumer to the service provider.

14. A computer program in accordance with claim 10 wherein said computer program further comprises at least one code segment configured to remit a refund payment to the consumer.

15. A computer program in accordance with claim 10 wherein the service provider provides services that include at least one of a lodging service, a travel service and an event service.

16. A computer program in accordance with claim 10 wherein the service includes at least one of a lodging reservation, a travel reservation and an event reservation.
